(19) United States
(12) Patent Application Publication
(10) Pub. No.: US 2019/0072738 A1
(43) Pub. Date: Mar. 7, 2019

(54) Modular Fiber Optic Cabling Infrastructure System

(71) Applicant: Optical Cable Corporation, Roanoke, VA (US)

(72) Inventors: Scott Fitzgerald, Roanoke, VA (US); Nicholas P. Guiffault, Allen, TX (US); Rick Hobbs, Frisco, TX (US); Jeff Miller, Grimes, IA (US); Sumio Seo, Wallingford, VT (US); Ian J. Timmins, Asheville, NC (US)

(73) Assignee: Optical Cable Corporation, Roanoke, VA (US)

(21) Appl. No.: 16/100,948

(22) Filed: Aug. 10, 2018

Related U.S. Application Data
(60) Provisional application No. 62/543,584, filed on Aug. 10, 2017.

(51) Int. Cl. G02B 6/44

(52) U.S. Cl. CPC G02B 6/4471; G02B 6/4454; G02B 6/4452

(57) ABSTRACT

A modular fiber optic cabling infrastructure system for use in combination with fiber optic cabling, connecting hardware and at least one corresponding transitionary device includes a chassis enclosure surrounding a cavity and forming a plurality of orifices for supporting incoming and exiting fiber optic cabling connections; a plurality of unique integration plates each being sized and configured for selective attachment to at least one of the plurality of orifices and each including a top surface and a bottom surface, the bottom surface of each of the plurality of unique integration plates forming an o-ring groove along a perimeter zone of the bottom surface, and wherein each of the plurality of unique integration plates is structured and disposed for supporting a corresponding style of connecting hardware; an o-ring sized for congruent receipt within the o-ring groove; and wherein each of the plurality of unique integration plates is selectively interchangeable.

### RELATED APPLICATION

This application claims the benefit of U.S. Provisional Patent Application Ser. No. 62/543,584 filed on Aug. 10, 2017.

### FIELD OF THE INVENTION

This invention relates to a modular cabling and connectivity system and, more particularly, a modular cabling and connectivity system including interchangeable components to promote a reconfigurable system in varying deployment environments.

### BACKGROUND OF THE INVENTION

Typically, the fiber optic cabling channel establishes physical link between two devices—(1) an Ethernet Switch; and (2) a device on the network. Each of these concepts are well established for local area networks (LANs). During installation or reconfiguration of incoming and exiting cable connections using presently available enclosures, permanent damage to the enclosure often can occur as these type of enclosures, especially the fiberglass variety, can be somewhat difficult to machine/drill for various cable or conduit mounting profiles. These types of enclosures can be very expensive. Being able to mount to a plate versus directly to the enclosure would offer some convenience and lower risk of ruining the enclosure during an installation.

There exists a need for a system for a customizable fiber optic cabling infrastructure being particularly adapted for implementation in environments in which the network switch and network device are dissimilar and therefore require different enclosures and connector components. More specifically, a modular/integration plate as part of the infrastructure system is needed for supporting different styles of connecting hardware across the different chassis enclosures which are suited for different counts of fiber in the cable and the respective environmental conditions.

### SUMMARY OF THE INVENTION

In accordance with one form of the present invention, there is provided a modular fiber optic cabling infrastructure system for use in combination with fiber optic cabling, connecting hardware and at least one corresponding transitionary device, the system including a chassis enclosure surrounding a cavity and forming a plurality of orifices for supporting incoming and exiting fiber optic cabling connections; a plurality of unique integration plates each being sized and configured for selective attachment to at least one of the plurality of orifices and each including a top surface and a bottom surface, the bottom surface of each of the plurality of unique integration plates forming an o-ring groove along a perimeter zone of the bottom surface, and wherein each of the plurality of unique integration plates is structured and disposed for supporting a corresponding style of connecting hardware; an o-ring sized for congruent receipt within the o-ring groove on the bottom surface of each of the plurality of unique integration plates; and wherein each of the plurality of unique integration plates is selectively interchangeable.

In accordance with another form of the invention, there is provided a modular fiber optic cabling infrastructure system for use in combination with fiber optic cabling, connecting hardware and at least one corresponding transitionary device, the system including a chassis enclosure surrounding a cavity and forming at least one orifice for supporting fiber optic cabling connections; a plurality of integration plates each being sized and configured for selective attachment to the at least one orifice and each including a top surface and a bottom surface, the bottom surface of each of the plurality of integration plates forming an o-ring groove along a perimeter zone of the bottom surface, and wherein each of the plurality of integration plates is structured and disposed for supporting a corresponding style of connecting hardware; an o-ring sized for congruent receipt within the o-ring groove on the bottom surface of each of the plurality of integration plates; and wherein each of the plurality of integration plates is selectively interchangeable.

### BRIEF DESCRIPTION OF THE DRAWINGS

For a fuller understanding of the nature of the present invention, reference should be made to the following detailed description, taken in conjunction with the accompanying drawings in which:

FIG. 1 is a schematic illustrating the division of the fiber optic cabling infrastructure into three distinct concepts beyond the TX/RX patch cords interfacing the LAN switch and device;

FIG. 2 is a perspective view of a wall mount enclosure in accordance with one embodiment;

FIG. 3 is a perspective view of a wall mount enclosure in accordance with another embodiment;

FIG. 4 is a perspective view of a wall mount enclosure in accordance with another embodiment;

FIGS. 5A and 5B are a perspective view and isolated perspective view thereof of a wall mount enclosure illustrating how a modular plate can be integrated to support modularity in the overall system by creating diversity in what connectors can be utilized with the same fiber optic enclosure;

FIG. 6 is a side elevational view illustrating a plurality of different styles of modular plates that can be supported by a specific chassis, each maintaining a common form factor in the modular plate;

FIG. 7 is a perspective view of a conventional wall mount enclosure suitable for usage in an indoor environment when installing fiber optic cabling infrastructure;

FIG. 8 is a perspective view illustrating removal of the modular plate from the wall of the chassis for supporting two different types of connectivity simultaneously;

FIG. 9 is a perspective view of an enclosure in accordance with another embodiment illustrating removal of the modular plate from the wall of a chassis;

FIG. 10 is a perspective view of a wall mount enclosure in accordance with another embodiment;

FIG. 11 is a side elevational view illustrating a plurality of different styles of modular plates that can be supported by a specific chassis, each maintaining a common form factor in the modular plate;

FIG. 12 is a perspective view of the modular plate illustrating an o-ring groove formed as part of the modular plate;

FIG. 13A is a side elevational view of the modular plate illustrating an o-ring groove formed as part of the modular plate;

FIG. 13B is a cross-sectional view of the modular plate taken from FIG. 13A;

FIG. 14 is an exploded view of the fiber optic cabling infrastructure in accordance with one embodiment of the present invention; and

FIG. 15 is an exploded view of the fiber optic cabling infrastructure in accordance with one embodiment of the present invention.

Like reference numerals refer to like parts throughout the several views of the drawings.

### DETAILED DESCRIPTION OF THE PREFERRED EMBODIMENTS

Referring to the several views of the drawings, the modular fiber optic cabling infrastructure system of the present invention is shown and generally indicated as 10.

In order to attain a highly flexible fiber optic cabling and connectivity infrastructure, the modular fiber optic cabling infrastructure system 10 includes a modular cabling and connectivity system centered around using interchangeable components to constitute a reconfigurable system based on different types of common deployment environments. The foundation for this is the implementation of a plurality of specialized integration plates 12 (the terms “integration plate” and “modular plate” are used interchangeably throughout and have the same meaning) to accommodate various corresponding connector types for different enclosures 14 targeted at supporting use in the different operating environments, wherein the modular plates 12 are secured to the wall 16 of the enclosure 14.

The premise of the invention is based around an established group of components in the fiber optic network topology that occur, allowing the designation of three major components to the installed cabling infrastructure:
1. Fiber Optic Cable
2. Methods of Implementation
3. Enclosures (Near and Far end)
   These constructs may be developed to provide interchangeability of any component within the installed fiber optic infrastructure, but it is typically assumed that the choice of these components is driven by two major considerations, including (1) the number of discrete fibers within the fiber optic cable and (2) the environment in which the cabling infrastructure is to be installed.

Functionally, a modular plate 12 is integrated into the different enclosures 14 to allow for easy and rapid interchangeability of the method by which the fiber optic trunk cable transitions to TX/RX fiber optic channels, typical of those used on Ethernet devices. The modular plate 12 integrated into several styles of enclosures 14 provides an easy mechanism to produce a “custom” solution for various operating environments in which fiber optic cabling infrastructure is desired. Moreover, the enclosures 14 can be formed from metal, fiberglass, molded plastic, or a combination thereof.

The modular fiber optic cabling infrastructure system 10 establishes the low-level construct around which the physical components of the invention are built. Within the communications channel, this invention uses three distinct constructs to establish the modularity and subsequent interchangeability to produce a pre-engineered end to end solution. It is assumed the basis of communications for the network switch and device is a TX/RX duplex pair, for which a standard fiber optic jumper cable is used. The three constructs used for transport of multiple TX/RX pairs for cabling infrastructure include:
1. Fiber Optic Cable—provides the bulk transport of multiple TX/RX pairs under a single extruded jacket. Different fiber counts provide fiber optic infrastructure to support different numbers of TX/RX pairs. Different jacket types are used to accommodate different environments within which the fiber optic infrastructure is to be installed.
2. Methods of Implementation—these devices are transitionary devices, which fundamentally provide access in TX/RX pairs to the fibers contained in the fiber optic cable. Typically, the fiber optic cable supports transport of fibers in groups of 8, 12 or 24, which may in turn may be combined to produce cable counts as a high as multiple hundred fiber count components. These transitionary devices may include conventional fiber optic components such as splice trays with pigtails, or fiber optic cassettes that utilize MPO connectors to provide bulk connectivity to industry standard simplex (SC) and duplex (LC) connectors used typically for the TX/RX pairs characteristic of the LAN switch and network device.
3. Connectivity Chassis (Near and Far End)—a specialized enclosure that accepts the macro level fiber optic cable, and then houses the transitionary device(s) within the chassis. These enclosures would typically be suited to different environmental applications, and the overall size would typically be driven by the number of fibers within the fiber optic cable. Most importantly, the enclosure is designed with a removable modular plate, that allows easy implementation of different bulkhead connector styles, or entry grommet to support MPO style installation or fiber optic splicing using splice trays and pig tails. Since the near and the far end of the channel may be installed in different environments, it is notable that the chassis and method of implementation style on the near end may be different than those used on far end.

Importantly, the three constructs articulated above may be applied to existing components used for fiber optic installation. The essence of this invention is the designation and subsequent interchangeability of these components to support different styles of connectivity in different enclosures in different operating environments.

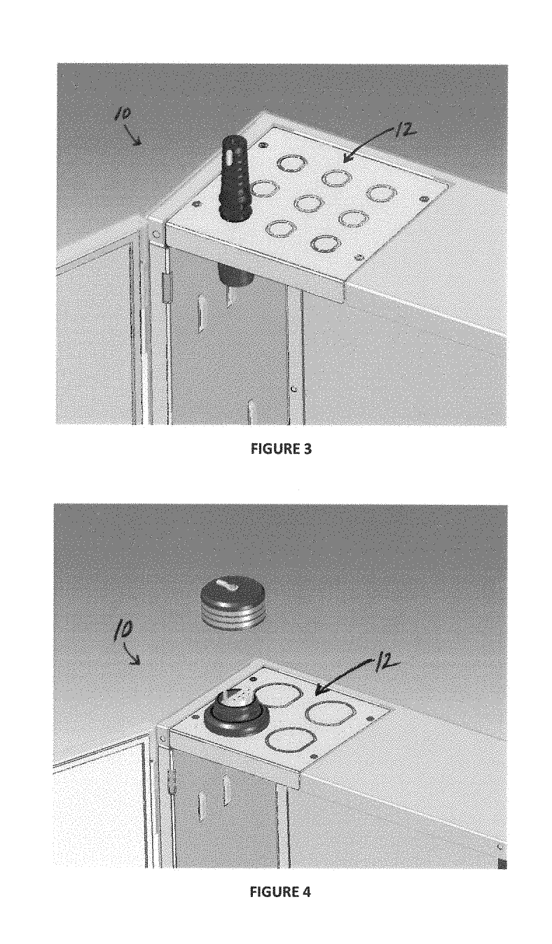

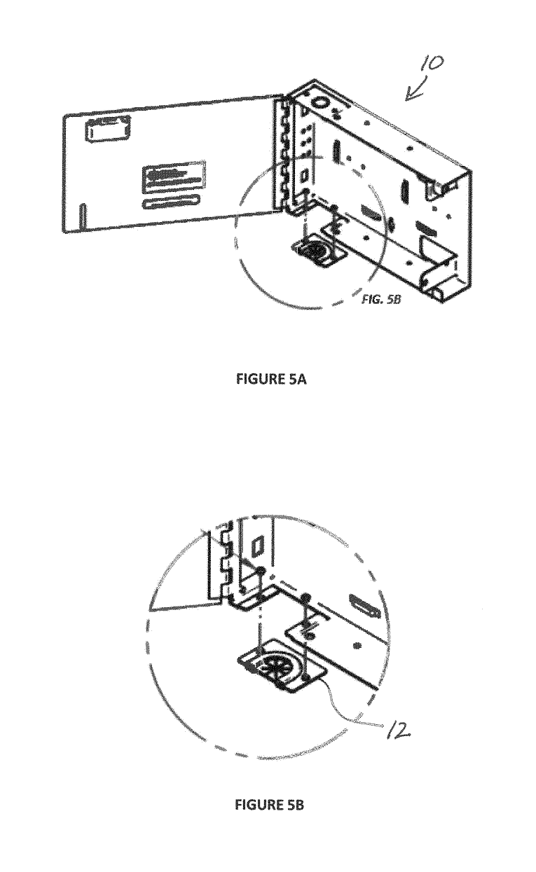

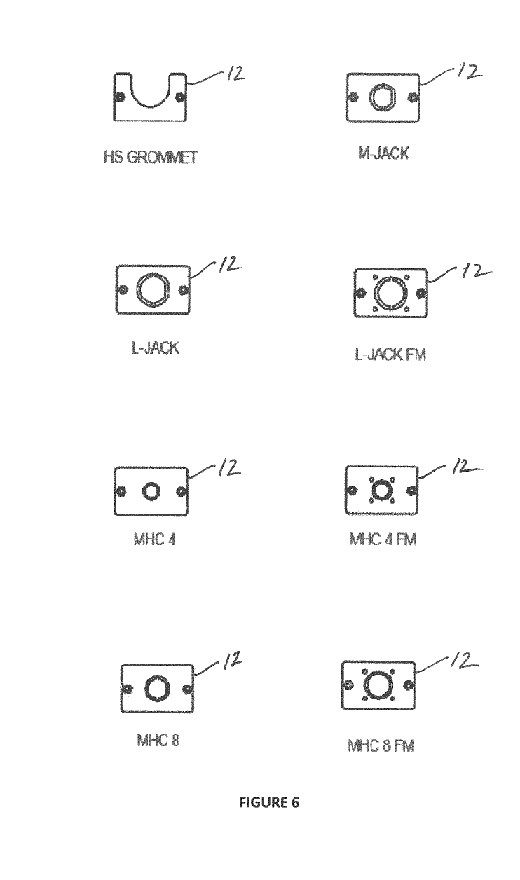

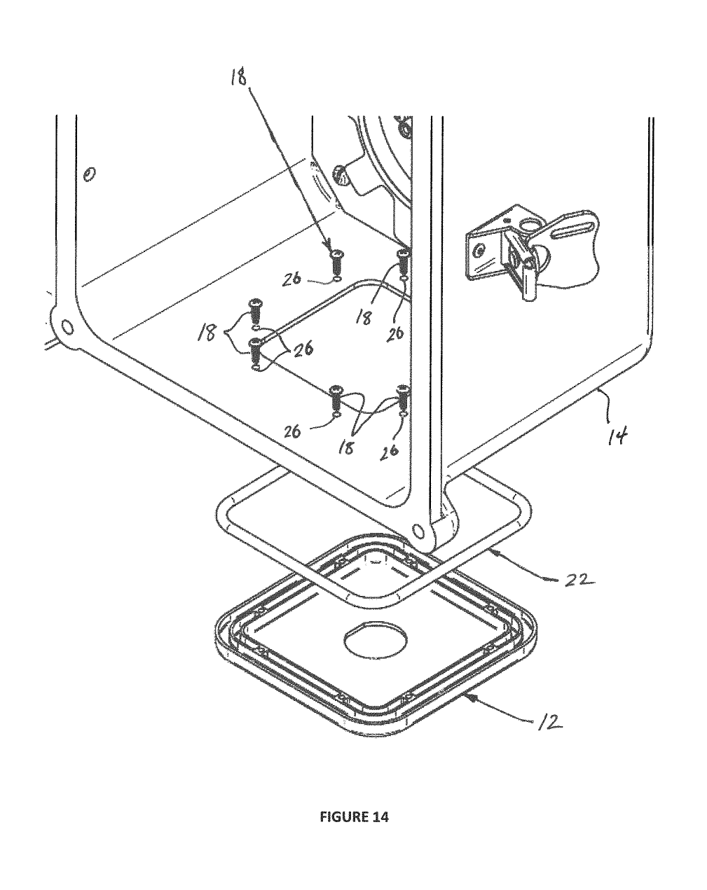

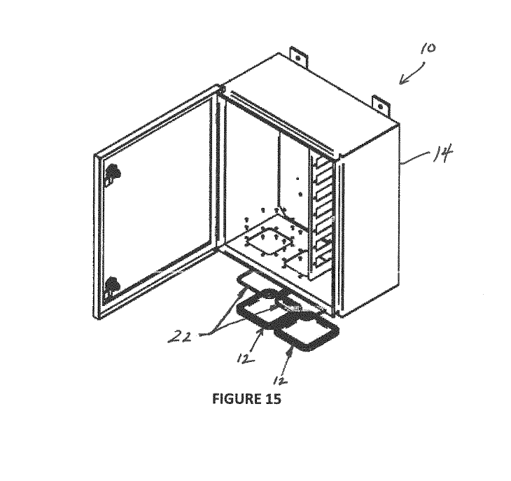

Referring to FIGS. 2-6, the enclosure 14 and corresponding modular plate 12 supports connector interchangeability. A fundamental attribute of this invention is the development of a modular plate that can be installed in an enclosure that provides the following two-fold functionality—(1) supports installation of different styles of fiber optic connectors that is removable and subsequently supports interchangeability of the connectors; and (2) uses multiple styles of enclosures, each with a modular plate, that are suited to different environments in which the fiber optic infrastructure is to be installed. As shown in FIG. 5B and, more particularly, FIG. 14, screws 18 are each for engaged receipt within the plurality of apertures 26 for securing each of the plurality of integrated plates 12 to the chassis enclosure 14.

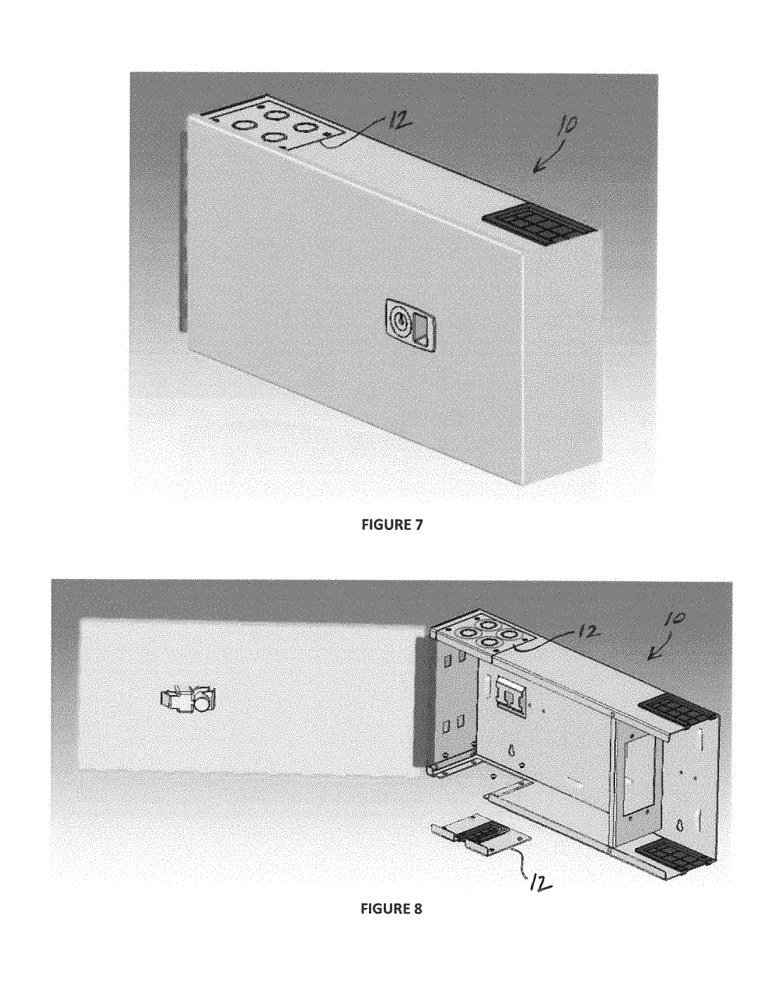

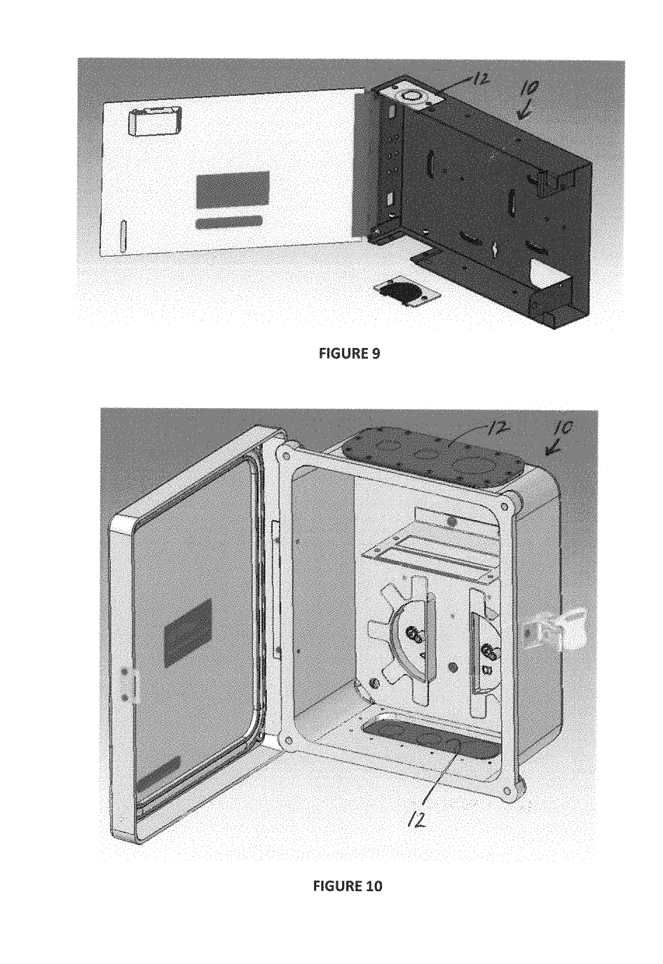

Referring to FIGS. 7-10, another fundamental attribute of this invention is the development different styles of chassis that act as enclosures 14 for installation of fiber optic cabling infrastructure in different environmental conditions. For example, in some cases a conventional wall mount enclosure can be used for indoor applications and requires minimal features to protect from precipitation or debris. FIG. 7 illustrates a conventional wall mount enclosure suitable for usage in an indoor environment when installing fiber optic cabling infrastructure. FIG. 8 illustrates a wall mount enclosure demonstrates how the modular plate can be removed in the wall of the chassis to support two different types of connectivity simultaneously. This style of enclosure is well suited to indoor applications where the environment is controlled. FIG. 9 illustrates another type of enclosure that demonstrates the modular plate concept, supporting overall lower fiber count than the enclosure depicted in FIG. 8. FIG. 10 illustrates a NEMA rated enclosure, suitable for outdoor usage, illustrates the modularity concept in a different style of enclosure than those depicted in FIGS. 7 and 8. The NEMA style enclosure is more suited to operation subject to the elements.

Different methods of implementation for the transition method between fiber optic cable and TX/RX channels typical of those used in devices that are Ethernet-enabled may be utilized. The invention proposes that these methods are interchangeable within the chassis enclosure 14, in combination with the modular plate 12 embedded in each chassis enclosure wall 16. Thus, in addition to different type of enclosures 14 being possible for different operating environments, method of implementation may also be chosen and subsequently interchanged at the preference of the user.

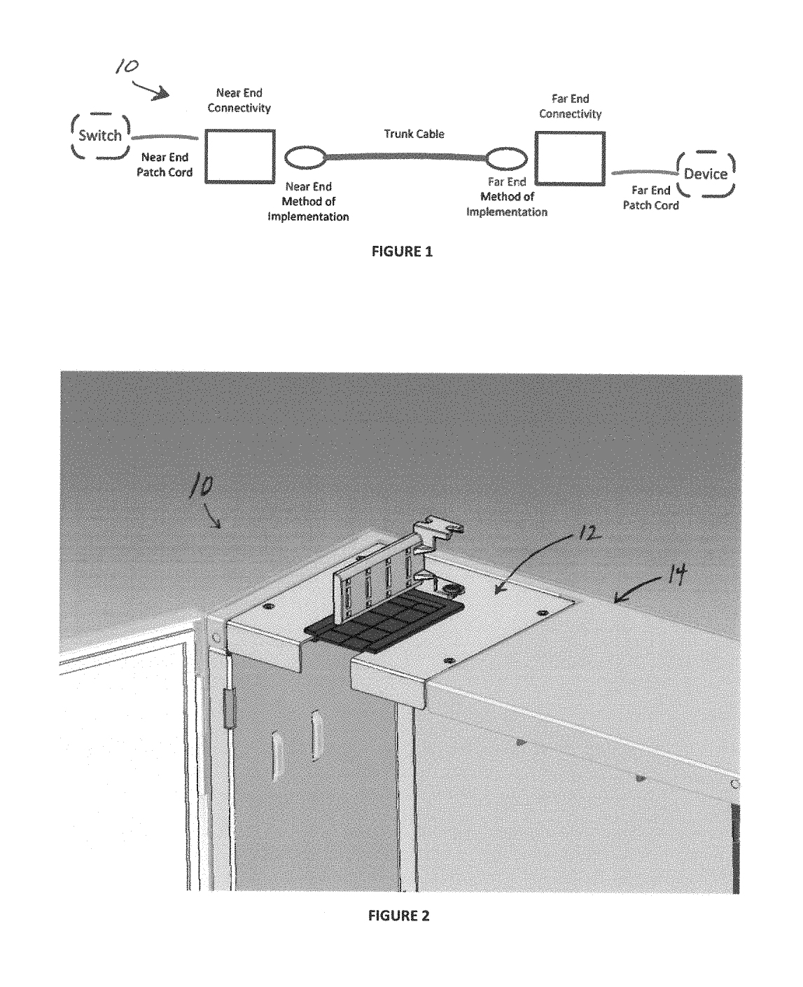

Typically, these methods of transition from fiber optic cable to discrete industry standard connector typical of usage on an Ethernet device, can be classified as one of the following constructs and combination of components. For circular receptacles, the receptacle body is mounted in the modular plate 12 which is installed in the enclosure 14. Typically, these styles of connectors are used for more harsh environment applications. The discrete fiber optic channels are then terminated with industry standard connectors and short segments of fiber optic cable, which travels inside the enclosure 14 from the external wall where the modular plate 12 is installed, to a second region inside the enclosure 14 where access to discrete connectors typical of the TX/RX pair are located. From this location, fiber optic jumpers (as depicted in FIG. 1) can be used to provide connectivity between the Ethernet switch or device and the installed fiber optic cabling infrastructure.

A fiber optic cassette can be used to transition between fiber optic cable upon which an MPO connector is installed, to discrete connectors typical of the TX/RX pair on an Ethernet device. For a cassette, this transition occurs within a single structure as a convenient sealed packaged. The fiber optic cable enters the enclosure typically through a grommet, and then proceeds to the region whereby access to discrete industry standard connectors are mounted for patching to the Ethernet switch or device. Though this is a standard method used in the fiber optic industry, it is necessary to accommodate this transition method with an appropriate modular plate 12 in the enclosure wall 16, which in turn supports interchangeability of this method with the other transitionary devices described herein.

A third common mechanism for installation of fiber optic cabling infrastructure is the usage of splice trays with pig tails. In this case the blunt end of the cable enters the enclosure, and then is fusion spliced onto discrete connectors of short segments of fiber in the field (pigtails) which are mated to an adapter plate for interface to patch cords typically used on Ethernet switches or devices. The cable entry mechanism to the enclosure is similar to that used for the MPO pre-terminated method described above.

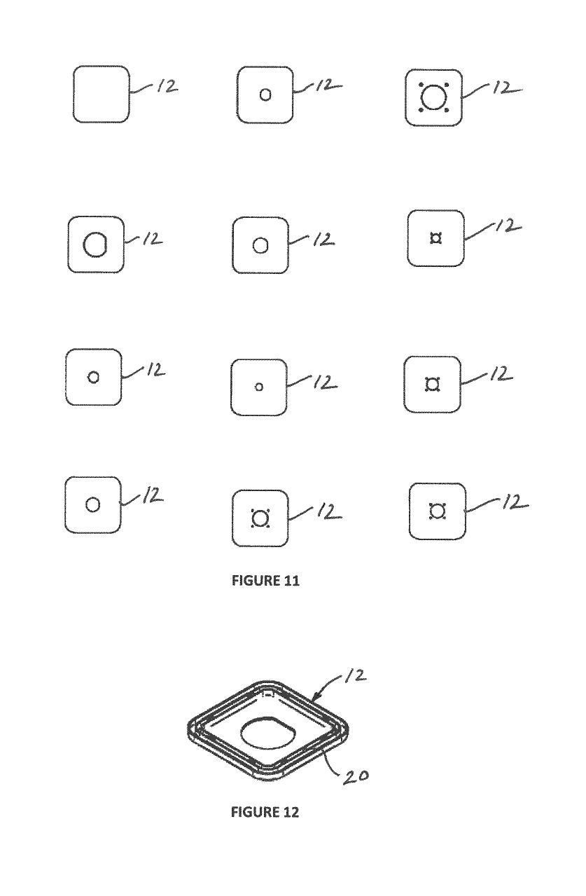

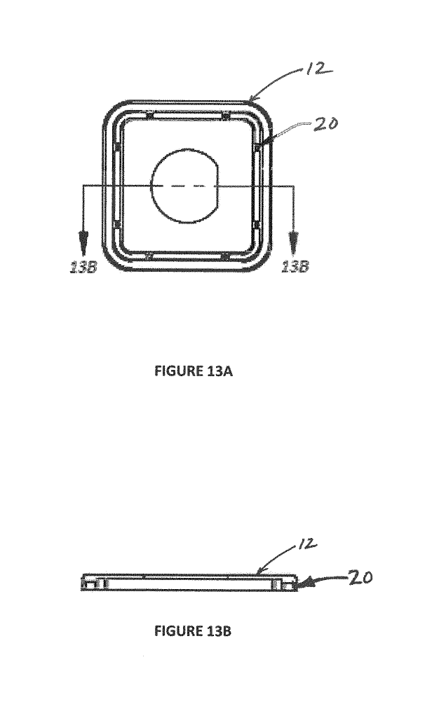

Referring to FIGS. 11-15, an embodiment of the modular plate 12 wherein an o-ring groove 20 is formed as part of the plate 12 and an o-ring 22 is sized for congruent receipt within the o-ring groove 20 on the bottom surface of each of the plurality of integration plates 12.

This invention describes a method and subsequent product set to design and install and manufacture a customizable fiber optic cabling infrastructure, particular well suited to infrastructure that is to be implemented where the environments in which the network switch and network device are different and require different enclosure and connector components. Generally, use of the replaceable plates described herein permit easy cable entry/exit customization without damaging the enclosure in the process. Therefore, being able to mount to a plate versus directly to the enclosure will offer some convenience and lower risk of ruining the enclosure during an installation.

Within this document, the method to establish an overall system level architecture comprised of fiber optic cable, enclosures (chassis) and method of implementation (transitionary devices) can be creates such that they are easy interchangeable with the implementation of a “modular plate” that supports different styles of connecting hardware, across different enclosures that are suited to different counts of fiber in the cable, and the respective environmental conditions. Use of such plates and enclosures are applicable for a wide variety of harsh environment cables which attach to the enclosure via either a jam nut or bolted flange connection, as well as to standard conduit fittings for copper or fiber optic applications.

While the present invention has been shown and described in accordance with several preferred and practical embodiments, it is recognized that departures from the instant disclosure are contemplated within the spirit and scope of the present invention.

What is claimed is:

1. A modular fiber optic cabling infrastructure system for use in combination with fiber optic cabling, connecting hardware and at least one corresponding transitionary device, the system comprising:
a chassis enclosure surrounding a cavity and forming a plurality of orifices for supporting incoming and exiting fiber optic cabling connections;
a plurality of integration plates each being sized and configured for selective attachment to at least one of the plurality of orifices and each including a top surface and a bottom surface, the bottom surface of each of the plurality of integration plates forming an o-ring groove along a perimeter zone of the bottom surface, and wherein each of the plurality of integration plates is structured and disposed for supporting a corresponding style of connecting hardware;
an o-ring sized for congruent receipt within the o-ring groove on the bottom surface of each of the plurality of integration plates; and
wherein each of the plurality of integration plates is selectively interchangeable.

2. The modular fiber optic cabling infrastructure as recited in claim 1 wherein each of the plurality of integration plates is selected from the group consisting of:
a blank integration plate;
an m-jack jam nut integration plate;
an ez 12-24 flange mount integration plate;
an ez 12-24 jam nut integration plate;
an ez 4 jam nut integration plate;
a mhc 4 flange mount integration plate;
a mhc 8 jam nut integration plate;
a mhc 4 jam nut integration plate;
a mhc 8 flange mount integration plate;
a I-jack jam nut integration plate;
an ez 4 flange mount integration plate; and
a I-jack flange mount integration plate.

3. The modular fiber optic cabling infrastructure as recited in claim 1 wherein the chassis enclosure is formed from metal.

4. The modular fiber optic cabling infrastructure as recited in claim 1 wherein the chassis enclosure is formed from fiberglass.

5. The modular fiber optic cabling infrastructure as recited in claim 1 wherein the chassis enclosure is formed from molded plastic.

6. The modular fiber optic cabling infrastructure as recited in claim 1 wherein each of the plurality of integration plates has a common form factor for supporting interchangeability of the plurality of integration plates.

7. The modular fiber optic cabling infrastructure as recited in claim 1 wherein the chassis enclosure and each of the plurality of integrated plates each form a plurality of corresponding apertures, and wherein the plurality of corresponding apertures of the chassis enclosure surround each of the plurality of orifices.

8. The modular fiber optic cabling infrastructure as recited in claim 7 further comprising a plurality of screws each being sized and configured for engaged receipt within the plurality of apertures for securing each of the plurality of integrated plates to the chassis enclosure.

9. A modular fiber optic cabling infrastructure system for use in combination with fiber optic cabling, connecting hardware and at least one corresponding transitionary device, the system comprising:
a chassis enclosure surrounding a cavity and forming at least one orifice for supporting fiber optic cabling connections;
a plurality of integration plates each being sized and configured for selective attachment to the at least one orifice and each including a top surface and a bottom surface, the bottom surface of each of the plurality of integration plates forming an o-ring groove along a perimeter zone of the bottom surface, and wherein each of the plurality of integration plates is structured and disposed for supporting a corresponding style of connecting hardware;
an o-ring sized for congruent receipt within the o-ring groove on the bottom surface of each of the plurality of integration plates; and
wherein each of the plurality of integration plates is selectively interchangeable.

10. The modular fiber optic cabling infrastructure as recited in claim 9 wherein each of the plurality of integration plates is selected from the group consisting of:
a blank integration plate;
an m-jack jam nut integration plate;
an ez 12-24 flange mount integration plate;
an ez 12-24 jam nut integration plate;
an ez 4 jam nut integration plate;
a mhc 4 flange mount integration plate;
a mhc 8 jam nut integration plate;
a mhc 4 jam nut integration plate;
a mhc 8 flange mount integration plate;
a I-jack jam nut integration plate;
an ez 4 flange mount integration plate; and
a I-jack flange mount integration plate.

11. The modular fiber optic cabling infrastructure as recited in claim 9 wherein the chassis enclosure is formed from metal.

12. The modular fiber optic cabling infrastructure as recited in claim 9 wherein the chassis enclosure is formed from fiberglass.

13. The modular fiber optic cabling infrastructure as recited in claim 9 wherein the chassis enclosure is formed from molded plastic.

14. The modular fiber optic cabling infrastructure as recited in claim 9 wherein each of the plurality of integration plates has a common form factor for supporting interchangeability of the plurality of integration plates.

15. The modular fiber optic cabling infrastructure as recited in claim 9 wherein the chassis enclosure and each of the plurality of integrated plates each form a plurality of corresponding apertures, and wherein the plurality of corresponding apertures of the chassis enclosure surround the at least one orifice.

16. The modular fiber optic cabling infrastructure as recited in claim 15 further comprising a plurality of screws each being sized and configured for engaged receipt within the plurality of apertures for securing each of the plurality of integrated plates to the chassis enclosure.
